(19) United States
(12) Patent Application Publication
(10) Pub. No.: US 2015/0156092 A1
(43) Pub. Date: Jun. 4, 2015

(54) SERVER MONITORING CIRCUIT

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: GUO-YI CHEN, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/217,491

(22) Filed: Mar. 18, 2014

(30) Foreign Application Priority Data
Nov. 29, 2013 (CN) 2013106172308

(51) Int. Cl. H04L 12/26

(52) U.S. Cl. CPC H04L 43/0817

(57) ABSTRACT

An exemplary server monitoring circuit includes a primary control circuit, a secondary control circuit, and an indicating circuit. The primary control circuit and the secondary control circuit are both electronically connected to the indicating circuit, and the primary control circuit is further electronically connected to the secondary control circuit. The primary control circuit has a priority to control the indicating circuit, which avoids the primary control circuit from interfering with the secondary control circuit effectively.

### BACKGROUND

1. Technical Field

The disclosure generally relates to server systems, and particularly to a server monitoring circuit.

2. Description of the Related Art

Data centers commonly include a plurality of servers, and each server has a corresponding indicating light that indicates a working state of the server. Currently, the indicating light can be controlled by two manners: the first manner is a manual. That is, a button is installed and is connected to the corresponding indicating light. When the user confirms that there is a server working abnormally, the user can operate the button to turn on the indicating light, thereby indicating the malfunctioning server. The second manner is using an integrated baseboard management controller (iBMC) to monitor the malfunctioned server. That is, when the iBMC detects that the server works abnormally, the iBMC outputs a corresponding control signal to turn on the indicating light.

However, when the indicating light is controlled by the second manner, it is easy for the second manner to interfere with the first manner. Thus, the user cannot determine a working state of the server accurately, and which is inconvenient for maintenance of the server.

Therefore, there is room for improvement within the art.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views. Wherever possible, the same reference numbers are used throughout the drawings to refer to the same or like elements of an embodiment.

FIG. 1 is a block diagram of a server monitoring circuit, according to an exemplary embodiment.

FIG. 2 is a circuit diagram of the server monitoring circuit shown in FIG. 1.

### DETAILED DESCRIPTION

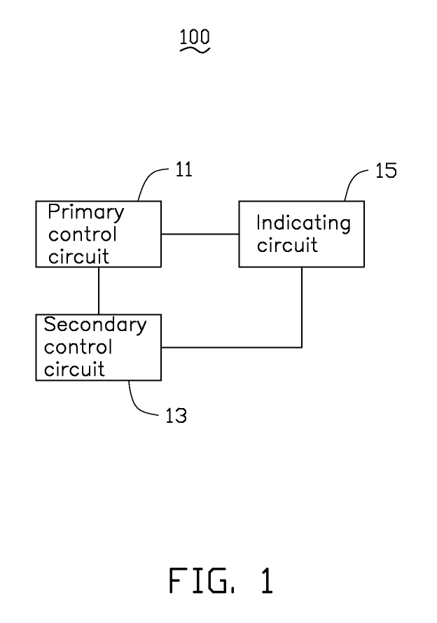

FIG. 1 is a block diagram of a server monitoring circuit 100, according to an exemplary embodiment. The server monitoring circuit 100 is used for monitoring a working state of a server (not shown), and includes a primary control circuit 11, a secondary control circuit 13, and an indicating circuit 15. The primary control circuit 11 and the secondary control circuit 13 are both connected to the indicating circuit 15. The primary control circuit 11 is also electronically connected to the secondary control circuit 13. When the primary control circuit 11 controls the indicating circuit 15, the primary control circuit 11 outputs a stop signal to the secondary control circuit 13, and the secondary control circuit 13 stops working. In this way, the primary control circuit 11 controls the indicating circuit 15. When the primary control circuit 11 does not control the indicating circuit 15, the primary control circuit 11 outputs a start signal opposite to the stop signal to the secondary control circuit 13, the secondary control circuit 13 starts working, and the indicating circuit 15 is completely controlled by the secondary control circuit 13.

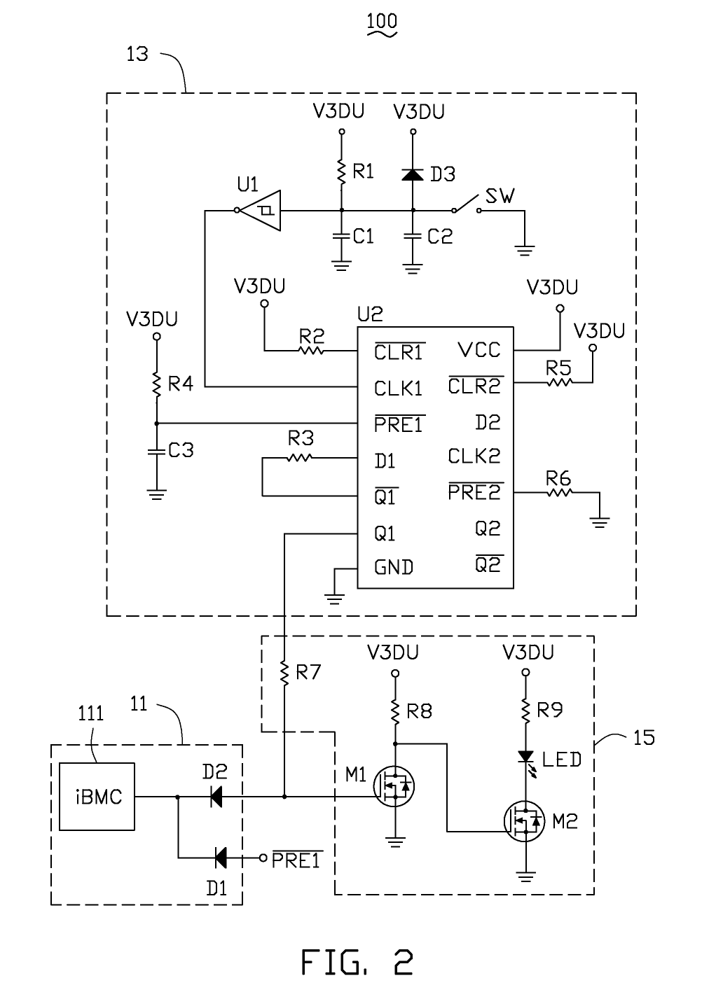

FIG. 2 shows the primary control circuit 11 including an integrated baseboard management controller (iBMC) 111, a first diode D1, and a second diode D2. The iBMC 111 outputs the stop signal and the start signal to control the secondary control circuit 13 to turn on or off. Cathodes of the first second diode D1 and the second diode D2 are both connected to the iBMC 111. An anode of the first diode D1 is connected to the secondary control circuit 13. An anode of the second diode D2 is electronically connected to the indicating circuit 15.

The secondary control circuit 13 includes a switch SW, a third diode D3, a resistor R1, two capacitors C1-C2, and a Schmitt trigger U1, and a drive chip U2. An end of the switch SW is grounded. Another end of the switch SW is electronically connected to a power supply V3DU by the resistor R1, and is further grounded by the capacitor C1. The end of the switch SW connected to the resistor R1 is electronically connected to an anode of the third diode D3, and is grounded by the capacitor C2. A cathode of the diode D3 is connected to the power supply V3DU. An input terminal of the Schmitt trigger U1 is electronically connected between the resistor R1 and the capacitor C1. An output terminal of the Schmitt trigger U1 is electronically connected to the drive chip U2.

The drive chip U2 includes a power pin VCC, a grounding pin GND, a first clock pin CLK1, a second clock pin CLK2, a first date pin Date1, a second date pin Data 2, a first preset pin P̅R̅E̅1̅, a second preset pin P̅R̅E̅2̅, a first clearing pin C̅L̅R̅1̅, a second clearing pin C̅L̅R̅2̅, a first positive output pin Q1, a second positive output pin Q2, a first negative output Q̅1̅, and a second negative output Q̅2̅.

The power pin VCC is electronically connected to the power supply V3DU. The grounding pin GND is grounded. The first clearing pin C̅L̅R̅1̅ is electronically connected to the power supply V3DU by a resistor R2. The first date pin Date1 is electronically connected to the first negative output Q̅1̅ by a resistor R3. The first pin clock pin CLK1 is connected to the output terminal of the Schmitt trigger U1. The first preset pin P̅R̅E̅1̅ is connected to the power supply V3DU by a resistor R4, and is grounded by a capacitor C3. The first positive output pin Q1 is electronically connected to the indicating circuit 15. The second clearing pin C̅L̅R̅2̅ is electronically connected to the power supply V3DU by a resistor R5. A resistor R6 grounds the second preset pin P̅R̅E̅2̅. Other pins are idle.

The indicating circuit 15 includes a first transistor Ml, a second transistor M2, and a lighting emitting diode LED. The first transistor M1 and the second transistor M2 are both N-channel field-effect transistors. A gate of the first transistor M1 is electronically connected to the anode of the second diode D2 of the primary control circuit 11 and is also electronically connected to the first positive output pin Q1 by a resistor R7. A drain of the first transistor M1 is electronically connected to power supply V3DU by a resistor R8. A source of the first transistor M1 is grounded. A gate of the second transistor M2 is electronically connected to the drain of the first transistor M1. A drain of the second transistor M2 is electronically connected to a cathode of the light emitting diode LED. A source of the second transistor M2 is grounded. An anode of the light emitting diode LED is electronically connected to power supply V3DU by a resistor R9.

In use, when the primary control circuit 11 does not control the indicating circuit 15, the primary control circuit 11 outputs the start signal. In this exemplary embodiment, the start signal is a high level signal (e.g., logic 1). In this way, the first diode D1 and the second diode D2 are both turned off to prevent the primary control circuit 11 from controlling the indicating circuit 15. At the same time, the first preset pin P̅R̅E̅1̅ of the drive chip U2 is electronically connected to the power supply V3DU by the resistor R4 to obtain a high level signal. According to a character of the drive chip U2, when the first preset pin P̅R̅E̅1̅ receives a high level signal, the drive chip U2 starts to work and an output of the first positive output pin Q1 is controlled by the first clock pin CLK1 and the first clearing pin C̅L̅R̅1̅.

In this exemplary embodiment, due to the first clearing pin C̅L̅R̅1̅ connected to the power supply V3DU by the resistor R2, the output of the first positive output pin Q1 is only controlled by the first clock pin CLK1. In detail, when the switch SW is not pressed, the Schmitt trigger U1 obtains a high level signal due to the input of the Schmitt trigger U1 being connected to the power supply V3DU by the resistor R1. The high level signal is processed (e.g., buffered) by the Schmitt trigger U1 and transmitted to the first clock pin CLK1. In this way, under a control of the first clock pin CLK1, the first positive output pin Q1 outputs a high level signal. The high level signal is further output to the gate of the transistor M1. Thus, the first transistor M1 is turned on and the second transistor M2 is turned off. Thereby, the light emitting diode LED is turned off and does not emit light, which indicates that the server corresponding to the switch SW is working normally.

When the switch SW is pressed, the input of the Schmitt trigger U1 is grounded by the switch SW to obtain a low level signal (e.g., logic 0). The low level signal is processed by the Schmitt trigger U1 and is transmitted to the first clock CLK1. In this way, the first positive pin Q1 outputs a low level signal. The low level signal from the first positive pin Q1 is further output to the gate of the first transistor M1. The first transistor M1 is turned off and the second transistor M2 is turned on. Thus, the cathode of the light emitting diode LED is grounded by the second transistor M2, and the light emitting diode LED is turned on, indicating that the server corresponding to the switch SW is working abnormally.

When the primary control circuit 11 controls the indicating circuit 15, the primary control circuit 11 outputs the stop signal. In this exemplary embodiment, the stop signal is a low level signal (e.g., logic 0). Thus, the first preset pin P̅R̅E̅1̅ is grounded to obtain a low level signal. According to a character of the drive chip U2, when the first preset pin P̅R̅E̅1̅ is a low level signal and the first clearing pin C̅L̅R̅1̅ is a high level signal, the first positive pin Q1 does not output any signal to the indicating circuit 15. In this way, the indicating circuit 15 is only controlled by the primary controlling circuit 11. For example, when the primary control circuit 11 outputs a low level signal, the first transistor M1 is turned off and the second transistor M2 is turned on. The second transistor M2 grounds the cathode of the light emitting diode LED. The light emitting diode LED is turned on, indicating that the server corresponding to the switch SW works abnormally.

In summary, the server monitoring circuit 100 includes the primary control circuit 11, the secondary control circuit 13, and the indicating circuit 15, which can ensure that the primary control circuit 11 has a priority to control the indicating circuit 15. That is, when the primary control circuit 11 does not control the indicating circuit 15, the secondary control circuit 13 controls the indicating circuit 15. Once the primary control circuit 11 controls the indicating circuit 15, the secondary control circuit 13 stops working at once, avoiding the primary control circuit 11 from interfering with the secondary control circuit 13 effectively, thereby the user can determine a working state of the server accurately, and which is convenient for maintenance of the malfunctioning server in time.

In the present specification and claims, the word “a” or “an” preceding an element does not exclude the presence of a plurality of such elements. Further, the word “comprising” does not exclude the presence of elements or steps other than those listed.

It is to be also understood that even though numerous characteristics and advantages of exemplary embodiments have been set forth in the foregoing description, together with details of the structures and functions of the embodiments, the disclosure is illustrative only, and changes may be made in detail, especially in matters of arrangement of parts within the principles of this disclosure to the full extent indicated by the broad general meaning of the terms in which the appended claims are expressed.

What is claimed is:

1. A server monitoring circuit, comprising:
a primary controlling circuit;
a secondary control circuit electronically connected to the primary controlling circuit; and
an indicating circuit electronically connected to the primary control circuit and the secondary controlling circuit;
wherein when the primary control circuit controls the indicating circuit, the primary control circuit outputs a stop signal to the secondary controlling circuit causing the secondary control circuit to stop working; when the primary control circuit does not control the indicating circuit, the primary control circuit outputs a start signal to the secondary controlling circuit, the secondary control circuit starts to work; the indicating circuit is controlled by the secondary controlling circuit.

2. The server monitoring circuit of claim 1, wherein the start signal is a high level signal.

3. The server monitoring circuit of claim 1, wherein the primary control circuit comprises an integrated baseboard management controller (iBMC), a first diode, and a second diode, cathodes of the first diode and the second diode are electronically connected to the iBMC, an anode of the first diode is electronically connected to the secondary controlling circuit, and an anode of the second diode is electronically connected to the indicating circuit.

4. The server monitoring circuit of claim 3, wherein the secondary control circuit comprises a switch and a drive chip, the drive chip comprises a clock pin, a preset pin, a clearing pin, and a positive output pin, an end of the switch is grounded, another end of the switch is electronically connected to a power supply and the clock pin, the preset pin is electronically connected to the anode of the second diode, the clearing pin is electronically connected to the power by a resistor, the positive output pin is electronically connected to the indicating circuit.

5. The server monitoring circuit of claim 4, wherein the end of the switch connected to the power supply is further grounded by a group of capacitors connected in parallel.

6. The server monitoring circuit of claim 4, wherein the end of the switch connected to the power supply is further connected to an anode of a third diode, a cathode of the third diode is electronically connected to the power supply.

7. The server monitoring circuit of claim 4, wherein the secondary control circuit further comprises a Schmitt trigger, an input terminal of the Schmitt trigger is electronically connected to the switch connected to the power supply, and an output terminal of the Schmitt trigger is electronically connected to the clock pin.

8. The server monitoring circuit of claim 4, wherein the indicating circuit comprises a first transistor, a second transistor, and a light emitting diode, a gate of the first transistor is electronically connected to the anode of the second diode and the positive output pin of the primary controlling circuit, a drain of the first transistor is electronically connected to the power supply, sources of the first transistor and the second transistor are grounded, a gate of the second transistor is connected to the drain of the first transistor, a drain of the second transistor is connected to a cathode of the light emitting diode, an anode of the light emitting diode is electronically connected to the power supply.

9. The server monitoring circuit of claim 8, wherein the first transistor and the second transistor are both N-channel field-effect transistors.
